(19) United States
(12) Patent Application Publication
(10) Pub. No.: US 2002/0147072 A1
(43) Pub. Date: Oct. 10, 2002

(54) Destructive vehicle operation prevention system

(75) Inventors: David J. Goodell, Beaverton, OR (US); David J. Knight, Avon Lake, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC

(21) Appl. No.: 09/832,085

(22) Filed: Apr. 10, 2001

(51) Int. Cl. B60K 41/20

(52) U.S. Cl. 477/183

(57) ABSTRACT

Operation of a vehicle, such as a tractor-trailer, is prevented or modified if operation of the vehicle would be dangerous or destructive due to a brake system abnormality. A motor controller limits the speed of a moving vehicle if a brake system reservoir pressure is below a predetermined threshold or if parking brakes are applied. Additionally, if there is a brake system abnormality, the motor controller limits the motor torque produced in a stationary or slowly moving vehicle. Electronically controlled brake system control modules are recruited to monitor brake system status information and report abnormalities to the motor controller. Preferably, the electronically controlled brake control modules communicate with the motor controller over a serial link.

### BACKGROUND OF THE INVENTION

1. Field of the Invention

The invention relates to the art of vehicle operation monitoring and control. The invention finds application where a driving force of a vehicle can be inappropriately opposed by a braking force of the vehicle. The invention will be described in relation to monitoring and control of a tractor-trailer type vehicle. However the invention is also applicable to other machines. For example, the invention may be beneficially applied in the operation and control of automobiles and electric vehicles as well as other vehicles and machines.

2. Description of Related Art

Tractor-trailer vehicles are capable of producing tremendous amounts of torque. Under normal circumstances that torque is beneficially put to use to move and accelerate heavy loads. However, due to operator error or system failure, that torque can also be misapplied. For example, a forgetful operator may attempt to drive the truck while parking brakes of the truck are still applied. Accidentally applying torque against the braking system of the truck can lead to various catastrophic failures. For example, applying engine torque against the mass and locked brakes or the vehicle can result in linking components of the drive train being twisted, stripped, snapped and otherwise torn apart. Alternatively, where the operator is successful in moving the truck against the force of the truck brakes, heat caused by the resulting friction could lead to a foundation brake thermal event.

Brake system failure can cause the brakes of a truck to be applied without the operator's knowledge. For example, a brake system failure may allow there to be insufficient air pressure available to disengage spring brakes associated with the truck. In a case such as this, the parking or spring brakes may remain engaged even though the operator takes action to disengage the brakes.

Insufficient air pressure can be detrimental in another way as well. While air pressure is required to disengage the spring brakes (parking brakes) of a truck, air pressure is required in order to apply the brakes that are normally used to stop the truck. Therefore, if there is insufficient air pressure available in a brake system reservoir, the stopping distance of the truck will not be optimal.

For the forgoing reasons, a system is needed that limits or prevents the movement of a vehicle when the brakes of the vehicle are applied, or when a brake system of the vehicle is not operating within specified parameters.

### BRIEF SUMMARY OF THE INVENTION

To those ends, a vehicle control system operative to improve safety and prevent damage to a drive train of a vehicle has been developed. The vehicle control system comprises an electronic brake system control module, a plurality of sensors operative to report brake system status information, and a motor control module operative to control the operation of at least a portion of the drive train based, at least in part, on the brake system status information.

The control system is operative to monitor the status of the brake system. If there is an abnormality in the brake system, the control system limits vehicle drive train output. Under certain circumstances the control system limits vehicle drive train torque output. In other circumstances the control system limits vehicle drive train output in order to limit vehicle speed.

One advantage to the present invention is found in the ability of the invention to reduce vehicle drive train damage by preventing accidental application of motor torque against wheels that are locked in place.

Another advantage of the present invention resides in the enhanced safety of a vehicle that cannot be operated if a brake system parameter is out of specification.

Yet another advantage of the present invention is the prevention of a foundation brake thermal event.

A further advantage of the present invention is the ability to implement some aspects of the invention without adding substantially to the hardware of prior art vehicles.

Still other advantages and benefits of the invention will become apparent to those skilled in the art upon a reading and understanding of the following detailed description.

### BRIEF DESCRIPTION OF THE DRAWINGS

The invention may take form in various components and arrangements of components, and in various steps and arrangements of steps. The drawings are only for purposes of illustrating preferred and are not to be construed as limiting the invention.

FIG. 1 is a schematic diagram of a truck (tractor) brake system operative to limit drive train output during brake system abnormalities;

FIG. 2 is a schematic diagram of a trailer brake system, operative to be connected to and operated through the truck brake system of FIG. 1, the trailer brake system being operative to aid in brakes system monitoring;

FIG. 3 is a schematic diagram of a dolly brake system, operative to be connected to and operated through the truck brake system of FIG. 1 directly or through connection to the trailer brake system of FIG. 2, the dolly brake system being operative to aid in brakes system monitoring; and

FIG. 4 is a flow chart outlining a method for monitoring a brake system and limiting drive train output during brake system abnormalities.

### DETAILED DESCRIPTION OF THE INVENTION

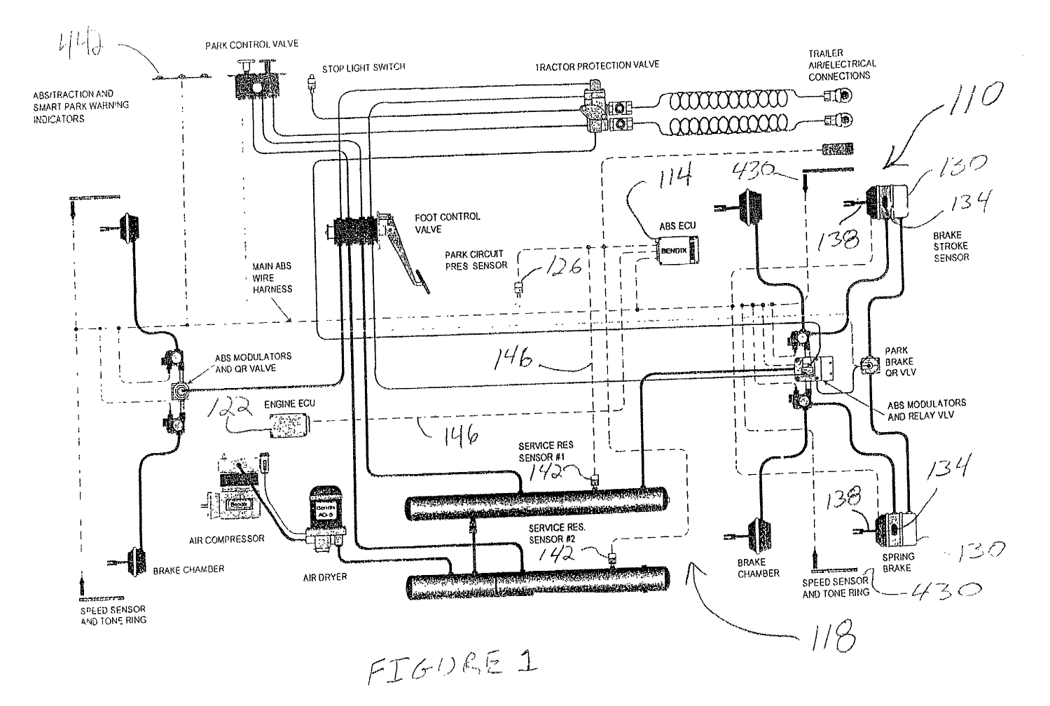

Referring to FIG. 1, a supervisory system 110 for preventing dangerous and damaging operation of a vehicle includes an electronically controlled brake system module 114, a plurality of sensors 118 that are operative to report brake system status information and a motor control module 122. Many prior art vehicles have electronically controlled brake modules. Typically these modules are in communication with brake system sensors. Additionally, electronically controlled brake modules are, at least in some instances, in communication with motor control modules. For example, some control brake system control modules communicate with motor control modules via J1922 or J1939 serial links. Furthermore, electronically controlled brake system modules typically comprise computational devices such as, for example, microprocessors. Therefore, the electronically controlled brake module is a convenient tie point and information processor for the supervisory system. In some embodiments, the supervisory system can be implemented by changing software in the electronically controlled brake system module 114 and in the motor control module 122. In other embodiments it may be necessary to make hardware changes that change the number or types of sensors 118 that can be connected to the electronically controlled brake system module. The sensors report system parameters that indicate the state of the brakes either directly or indirectly. For example, the plurality of sensors can include a parking or spring brake pressure sensor 126. If the spring brake pressure sensor 126 reports a high pressure in the spring brake system, the report is a strong indication that spring brakes 130 of the truck are released. However, it is possible that one or more spring brakes 130 are engaged even though there is high pressure in a spring brake system. For example, component failure or corrosion may prevent a spring brake 130 from disengaging. Therefore, the supervisory system may optionally comprise spring brake chamber stroke sensors 134. A potentiometer or switch may be included in the spring brake 130 assemblies for reporting the position of a spring brake actuator arm 138. The plurality of sensors 118 may also include service reservoir pressure sensors 142 or switches to monitor compressed air stored in the service reservoir. Normally, as air from the tanks is used to engage and disengage the brakes of the truck, a compressor replenishes the supply of compressed air, thereby preventing the pressure in the reservoirs from falling below a predetermined level. If a failure occurs in the reservoir system, air pressure in the service reservoirs can fall below the predetermined level, thereby preventing the brakes from performing optimally. For example, a leak can develop in the service reservoir system. Alternatively, a failure can occur in the replenishment compressor, thereby preventing air pressure replenishment. Service reservoir pressure sensors 142 or switches report any such drop or loss in pressure to the electronically controlled brake system module 114. The motor control module 122 receives brake system status information, either from the brake system control module 114 as described here or directly from the brake systems sensors. The motor control module 122 may receive information directly from sensors in implementations without brake system control modules 114. Either way, communication is preferably through a serial link 146. Typically the motor control module 122 is an internal combustion engine control module, such as, for example, a diesel engine control module. However, other motor control modules are contemplated. The supervisory system can be implemented with an electric motor control module. If the electronically controlled brake system control module 122 and/or the plurality of sensors 118 report that an abnormality exists in the brake system, the motor control module takes appropriate action to prevent detrimental operation of the vehicle. The motor control module 122, for example, controls the motor so as to limit the torque produced by the motor. Alternatively, the motor control module 122 controls the motor so as to limit the speed of the vehicle.

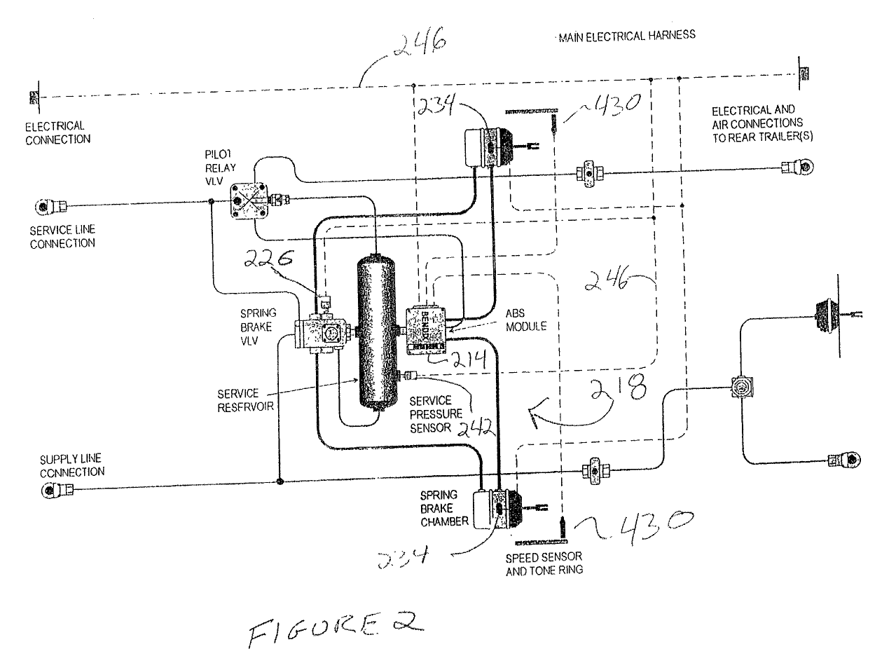

In a tractor-trailer system, it is preferable to also monitor and react to the status of the trailer brake system. Referring to FIG. 2, preferably a trailer brake system 210 also comprises an electronically controlled brake module 214 and a plurality of sensors 218. Again, the plurality of sensors 218 comprises a spring brake pressure sensor 226 and/or a spring brake chamber stroke sensor 234 and/or a service pressure sensor 242 or switch. The trailer electronically controlled brake control module 214 communicates with the motor control module 122 either directly or through the services of the tractor electronically controlled brake module 214. Either way, communication is preferably through a serial link 246.

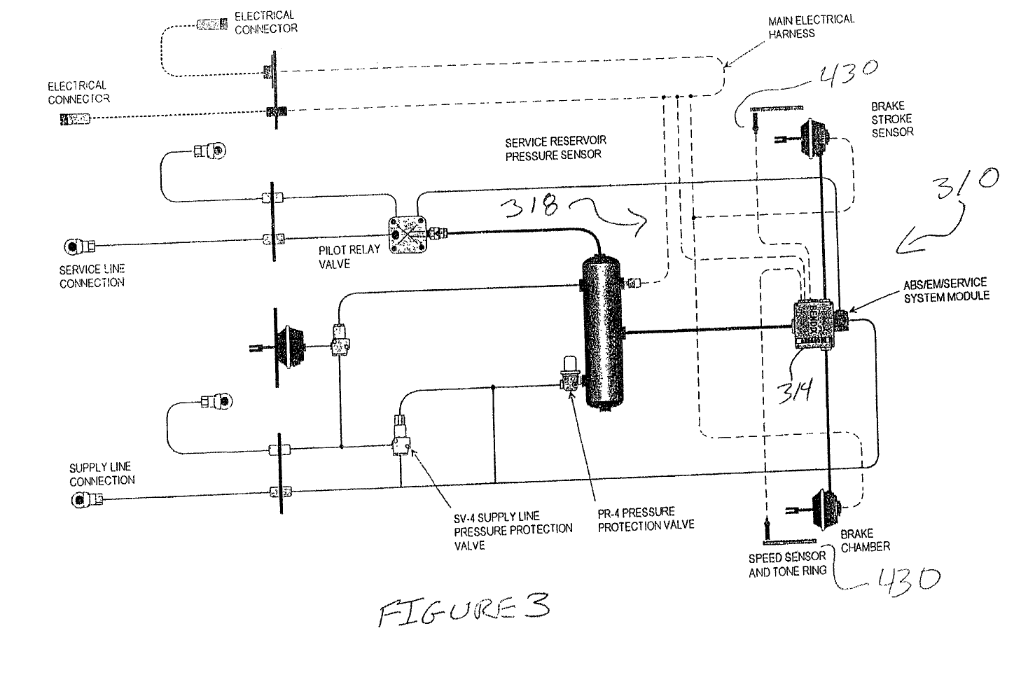

Those skilled in the art will understand that the system can be expanded as required. For instance, referring to FIG. 3, a dolly brake system 310 also comprises an electronically controlled brake module 314 and a plurality of sensors 318. The plurality of sensors 318 comprises a spring brake pressure sensor 326 and/or a spring brake chamber stroke sensor 334. The dolly brake control module 314 communicates with the motor control module 122 either directly or through the services of the trailer 214 and/or tractor 114 electronically controlled brake modules, again, preferably through a serial link 346.

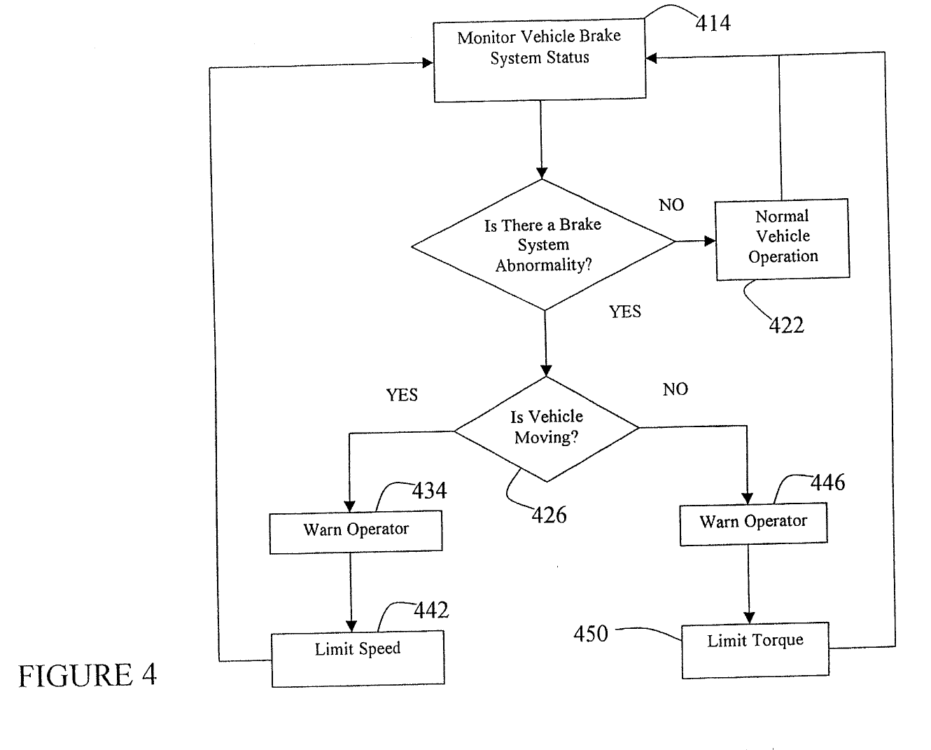

Referring to FIG. 4, in a brake system monitoring step 414 the supervisory system reviews input from the plurality of sensors from the tractor and, if applicable, the trailer and the dolly. If the brake system is operating within normal parameters, vehicle operation continues normally 422 and the supervisory system continues to monitor the brake system 414. If one or more of the sensors and/or electronically controlled brake control modules reports an abnormality in the brake system, such as an engaged spring brake or a low service reservoir pressure, a vehicle status test step 426 is performed. The vehicle status test 426 reports vehicle movement. Vehicle movement information is provided by, for example, the brake control modules 114, 214, 314. It is known in the art that electronically controlled brake control modules are informed about vehicle movement by a plurality of wheel movement sensors 430 (see FIGS. 1, 2 and 3). Alternatively the motor control module 122 can determine vehicle movement status from information the motor control module 122 has about motor and transmission speed. If the vehicle is moving or moving above a predetermined speed, the operator is warned, in a first operator-warning step 434, that the supervisory system is limiting speed and the speed of the vehicle is limited in a vehicle speed-limiting step 438. An indicator light 442 (see FIG. 1) for instance is actuated to warn the operator of supervisory system action and the operator is prevented from accelerating. Preferably the operator responds by slowing the vehicle and pulling over. With each application of the brakes, the vehicle speed is limited to the speed achieved by the application of the brakes. If the vehicle is not moving, or is moving below the predetermined speed, the operator is warned in second operator warning step 446 that the supervisory system is limiting torque and in a motor torque limiting step 450 the motor control module 122 controls the motor in such a way as to limit the torque delivered by the motor.

Methods of controlling motors to limit torque are known in the art. Limiting the torque delivered by the motor will limit movement of the truck, although the torque limit is high enough to allow the vehicle to move slowly. With motor torque limited and the vehicle limited to extremely slow movements, the operator must attend to the brake system abnormality.

The invention has been described with reference to preferred embodiments. Obviously, modifications and alterations will occur to others upon a reading and understanding of this specification. The invention is intended to include all such modifications and alterations insofar as they come within the scope of the appended claims or the equivalents thereof.

What is claimed is:

1. A vehicle control system operative to improve safety and prevent damage to a drive train of a vehicle, the vehicle control system comprising:
an electronically controlled brake system control module;
a plurality of sensors operative to report brake system status information to the electronically controlled brake system control module; and
a motor control module operative to receive brake system status information from the electronically controlled brake system and to control the operation of at least a portion of the drive train based, at least in part, on the brake system status information.

2. The vehicle control system of claim 1 wherein the plurality of sensors comprises a spring brake pressure sensor.

3. The vehicle control system of claim 1 wherein the plurality of sensors comprises a brake chamber stroke sensor.

4. The vehicle control system of claim 1 wherein the plurality of sensors comprises a low-pressure switch.

5. The vehicle control system of claim 1 wherein the plurality of sensors comprises a trailer spring brake pressure sensor.

6. The vehicle control system of claim 1 wherein the plurality of sensors comprises a trailer brake chamber stroke sensor.

7. The vehicle control system of claim 1 wherein the plurality of sensors comprises a trailer brake system low-pressure switch.

8. The vehicle control system of claim 1 wherein the plurality of sensors comprises a dolly spring brake pressure sensor.

9. The vehicle control system of claim 1 wherein the plurality of sensors comprises a dolly brake chamber stroke sensor.

10. The vehicle control system of claim 1 further comprising:
a communications path interconnecting between the electronically controlled brake system control module and the motor control module.

11. The vehicle control system of claim 10 wherein the motor control module receives the brake system status information from the electronically controlled brake system control module over the communications path.

12. The vehicle control system of claim 1 further comprising:
a status indicator operative to inform an operator of the vehicle about the manner in which the motor control module is controlling the operation of the drive train.

13. The vehicle control system of claim 1 wherein the motor control module controls the drive train of the vehicle in a manner which limits torque produced by the drive train when the brake system status information includes an indication that at least one brake is at least partially engaged.

14. The vehicle control system of claim 1 wherein the motor control module controls the drive train of the vehicle in a manner that limits vehicle speed when the brake system status information includes an indication that there is an abnormality in the brake system.

15. A method of controlling the operation of a vehicle operative to prevent damage to vehicle components, the method comprising the steps of:
monitoring the status of a brake system of the vehicle; and
limiting vehicle drive train output when there is, or is likely to be, at least partial engagement of at least one of the brakes of the vehicle, thereby preventing damage to vehicle components.

16. The method of controlling the operation of a vehicle of claim 15 where in the step of monitoring engagement status further comprises monitoring spring brake pressure.

17. The method of controlling the operation of a vehicle of claim 15 where in the step of monitoring engagement status further comprises monitoring brake stroke position.

18. The method of controlling the operation of a vehicle of claim 15 where in the step of monitoring engagement status further comprises monitoring service reservoir pressure.

19. The method of controlling the operation of a vehicle of claim 15 where in the step of limiting drive train output further comprises limiting drive train torque.

20. The method of controlling the operation of a vehicle of claim 15 where in the step of limiting drive train output further comprises limiting drive train output so as to limit vehicle speed.

21. The method of controlling the operation of a vehicle of claim 15 further comprising:
warning an operator of the vehicle that limiting steps are being taken.
